(19) United States
(12) Patent Application Publication
(10) Pub. No.: US 2026/0023342 A1
(43) Pub. Date: Jan. 22, 2026

(54) SHEET FEEDING APPARATUS AND IMAGE FORMING APPARATUS

(71) Applicant: CANON KABUSHIKI KAISHA, Tokyo (JP)

(72) Inventor: Hiroshi Sagawa, Ibaraki (JP)

(21) Appl. No.: 19/254,110

(22) Filed: Jun. 30, 2025

(30) Foreign Application Priority Data
Jul. 16, 2024 (JP) 2024-113320

(51) Int. Cl. G03G 15/00

(52) U.S. Cl. CPC G03G 15/6511; G03G 2215/00556; G03G 2215/00721

(57) ABSTRACT

A sheet feeding apparatus includes a tray disposed at a side part of an apparatus body and supporting a sheet, a feed unit feeding the sheet supported on the tray, a detection unit detecting that the sheet has been fed by the feed unit, an air blowing unit blowing air to the sheet supported on the tray, and a control unit executing a feeding operation to feed the sheet by the feed unit and a blowing operation to blow the air by the air blowing unit, respectively. The control unit is configured to execute a retry operation to re-execute the feeding operation in a case where the detection unit does not detect feeding of the sheet within a predetermined time after executing the feeding operation, and execute a first blowing mode to execute the blowing operation after executing the feeding operation and before executing the retry operation.

### BACKGROUND

### Field of the Technology

This disclosure relates to a sheet feeding apparatus that feeds a sheet, and an image forming apparatus that includes the sheet feeding apparatus.

### Description of the Related Art

Image forming apparatuses, such as printers and facsimiles, include manual feed trays and feed cassettes as a sheet feeding apparatus to feed sheets to image forming units that form images on the sheets, or feed decks and the like are attached externally. In addition, for this application, a system is proposed that directs air to the sheets, which are set, and enables levitation to separate the sheets (refer to Japanese Patent Laid-Open No. H04-23747).

However, in the sheet feeding apparatus described in Japanese Patent Laid-Open No. H04-23747, to prevent the excessive separation of the sheets, after blowing the air at the start of an image forming job, subsequently the air is not blown onto a feed tray until all the sheets on the feed tray have been depleted. Therefore, there is a risk that feeding errors may occur due to adhesive forces between the sheets.

### SUMMARY

This disclosure aims to provide a sheet feeding apparatus and an image forming apparatus that can suppress the occurrence of the feeding errors of the sheet.

According to a first aspect of the present disclosure, a sheet feeding apparatus includes a tray disposed at a side part of an apparatus body and configured to support a sheet, a feed unit configured to feed the sheet supported on the tray, a detection unit configured to detect that the sheet has been fed by the feed unit, an air blowing unit configured to blow air to the sheet supported on the tray, and a control unit configured to execute a feeding operation to feed the sheet by the feed unit and a blowing operation to blow the air by the air blowing unit, respectively. The control unit is configured to execute a retry operation to re-execute the feeding operation in a case where the detection unit does not detect feeding of the sheet within a predetermined time after executing the feeding operation, and execute a first blowing mode to execute the blowing operation after executing the feeding operation and before executing the retry operation.

According to a second aspect of the present disclosure, an image forming apparatus includes the sheet feeding apparatus, and an image forming unit configured to form an image on the sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming system according to this embodiment.

FIG. 2 is a block diagram illustrating a control system of the image forming system according to this embodiment.

FIG. 3 is a perspective view illustrating a manual sheet feed portion according to this embodiment.

FIG. 4 is a side view illustrating the manual sheet feed portion according to this embodiment.

FIG. 5 is a flowchart illustrating an operation procedure of the manual sheet feed portion according to this embodiment.

### DESCRIPTION OF THE EMBODIMENTS

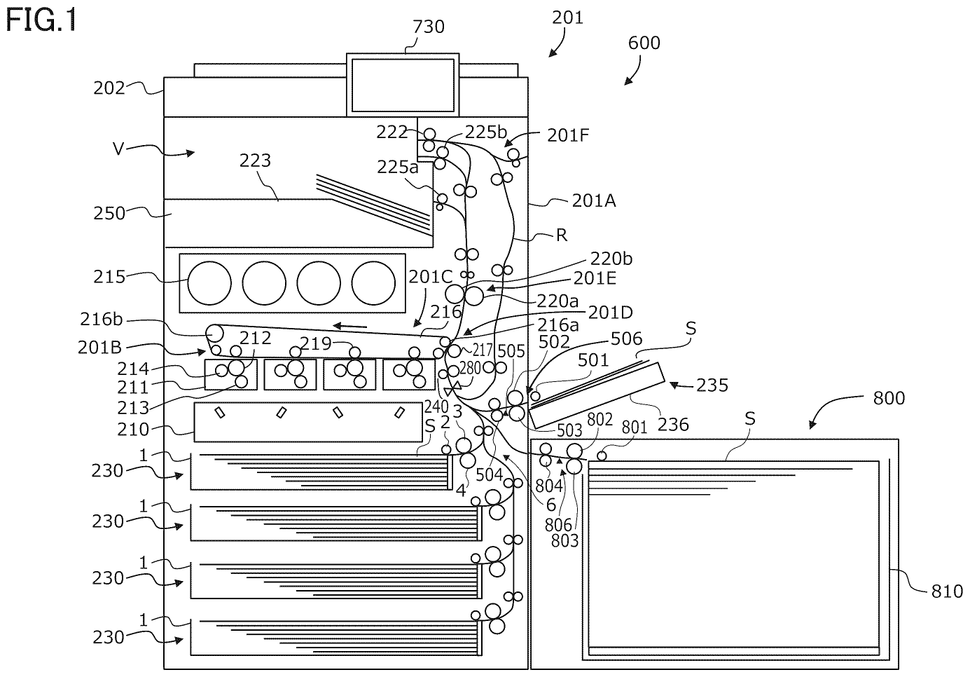

Hereinafter, with reference to drawings, this embodiment according to this disclosure will be described in detail. First, using FIG. 1, an image forming system 600 that includes an image forming apparatus 201 and a feed deck 800 connected to the image forming apparatus 201 will be described. FIG. 1 is a diagram illustrating a schematic configuration of the image forming system 600 according to this embodiment.

### Schematic Configuration of Image Forming System

As illustrated in FIG. 1, the feed deck 800 is connected to a right side in FIG. 1 of the image forming apparatus 201, and is configured to feed a sheet S to an image forming unit 201B of the image forming apparatus 201. In addition, also a manual sheet feed portion 235 is configured to feed the sheet S to the image forming unit 201B of the image forming apparatus 201.

### Schematic Configuration of Image Forming Apparatus

As illustrated in FIG. 1, the image forming apparatus 201 includes an apparatus body 201A, equipped with the image forming unit 201B that forms an image on the sheet. An image reading apparatus 202, which is installed substantially horizontally, is arranged on top of the apparatus body 201A. In addition, between these image reading apparatus 202 and apparatus body 201A, a sheet discharge space V for discharging the sheet is formed. In addition, an operation unit 730, which is a user interface (UI) including a touch panel, which is configured to display a screen, and the like, is arranged on top of the apparatus body 201A. The operation unit 730 is an example of an output portion that outputs information, and includes, for example, a liquid crystal touch panel.

The image forming unit 201B employs a configuration in which a four-drum full color system is applied. The image forming unit 201B includes a laser scanner 210 and four process cartridges 211Y, 211M, 211C, and 211K that form toner images of four colors: yellow (Y), magenta (M), cyan (C), and black (K). Each process cartridge 211 includes a photosensitive drum 212, a charge unit 213, serving as a charging means, and a developing unit 214, serving as a developing means. In addition, the image forming unit 201B includes an intermediate transfer unit 201C and a fixing unit 201E, which are arranged above the process cartridges 211. Toner cartridges 215 for supplying toner to the developing units 214 are disposed above the intermediate transfer unit 201C.

The intermediate transfer unit 201C includes an intermediate transfer belt 216, which is wound around a drive roller 216a and a tension roller 216b. To be noted, primary transfer rollers 219, which come into contact with the intermediate transfer belt 216 at positions opposite the photosensitive drums 212 are disposed inside the intermediate transfer belt 216. Here, the intermediate transfer belt 216 is rotated in an arrow direction in FIG. 1 by the drive roller 216a, which is driven by a driving unit, not shown.

Then, the toner images of each color with negative polarity on the photosensitive drums 212 are sequentially multi-transferred onto the intermediate transfer belt 216 by the primary transfer rollers 219. A secondary transfer roller 217 that transfers a color image formed on the intermediate transfer belt 216 onto the sheet S is disposed at a position opposite the drive roller 216a of the intermediate transfer belt 216. A secondary transfer portion 201D is formed between these intermediate transfer belt 216 and secondary transfer roller 217. Further, the fixing unit 201E including a pressing roller 220a and a heating roller 220b is arranged above this secondary transfer roller 217. In addition, a first sheet discharge roller pair 225a, a second sheet discharge roller pair 225b, and a duplex reverse portion 201F are arranged above this fixing unit 201E. In this duplex reverse portion 201F, a reverse roller pair 222, capable of rotating forward and reverse, a reconveyance path R, for once again conveying the sheet with the image formed on a first surface to the image forming unit 201B, and the like are disposed.

In a lower part of the apparatus body 201A, a plurality of sheet feed units 230, which feed the loaded sheet S to the image forming unit 201B, are disposed. Each of the plurality of sheet feed units 230 includes a feed cassette 1, storing a plurality of sheets (sheet bundle), and a sheet feeding unit 6, serving as a feeding unit to feed the sheet S stored in the feed cassette 1. The sheet feeding unit 6 includes a pickup roller 2, and a feed roller 3 and a retard roller 4, collectively serving as a separation means to separate the sheets S which are delivered from the pickup roller 2 in an overlapping manner.

In addition, on the right side surface in FIG. 1 of the apparatus body 201A and below the manual sheet feed portion 235, the feed deck 800, which delivers the loaded sheet S to the image forming unit 201B, is disposed. Similarly to the sheet feed unit 230, the feed deck 800 includes a sheet feeding unit 806. That is, the sheet feeding unit 806 includes a pickup roller 801, and a feed roller 802 and a retard roller 803, collectively serving as a separation means to separate the sheets S which are delivered from the pickup roller 801 in an overlapping manner. In addition, an extraction roller pair 804 is disposed downstream of the sheet feeding unit 806 in a sheet conveyance direction.

In addition, on the right side surface in FIG. 1 of the apparatus body 201A, the manual sheet feed portion 235, which feeds the sheet S to the image forming unit 201B from a plurality of sheets S (sheet bundle), which are stacked manually, is disposed. The manual sheet feed portion 235 includes a sheet tray 236, serving as an opening/closing portion. The sheet tray 236 is disposed on a side part of the apparatus body 201A, and is a manual feed tray on which the sheet S can be manually stacked. The sheet tray 236 can move in an opening and closing direction by pivoting with respect to the apparatus body 201A. That is, the sheet tray 236 is arranged to be switchable between an open state of being opened with respect to the apparatus body 201A, and a closed state of being closed with respect to the apparatus body 201A. The sheet tray 236 is configured to support the sheet S in the open state.

In addition, similarly to the sheet feed unit 230, the manual sheet feed portion 235 includes a sheet feeding unit 506. The sheet feeding unit 506 is an example of the feeding unit, and feeds the sheet S stacked on the sheet tray 236. That is, the sheet feeding unit 506 includes a pickup roller 501, and a feed roller 502 and a retard roller 503, collectively serving as a separation means to separate the sheets S which are delivered from the pickup roller 501 in an overlapping manner. In addition, an extraction roller pair 504 is disposed downstream of the sheet feeding unit 506 in the sheet conveyance direction.

To be noted, a media detection sensor 280, serving as a type detection unit, is arranged in a conveyance path of the apparatus body 201A, and detects a grammage and surface characteristics of a conveyed sheet S.

### Operation of Image Forming Apparatus

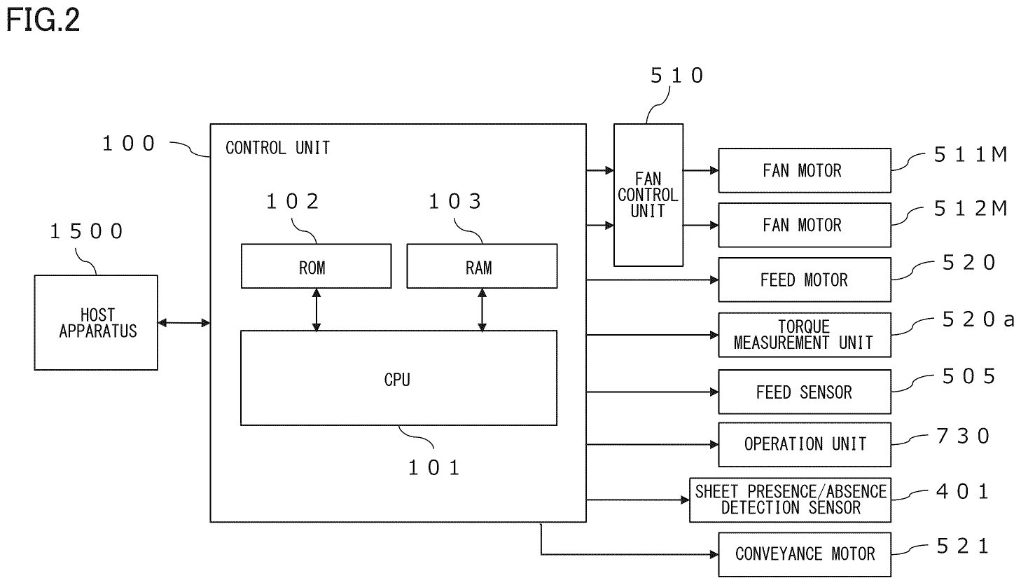

Next, an image forming operation of the image forming apparatus 201 will be described. First, for example, when image information of a document is read by the image reading apparatus 202, this image information is converted into an electrical signal subsequent to image processing, and is transmitted to the laser scanner 210 of the image forming unit 201B. To be noted, this image information may be transmitted from a host apparatus 1500 (refer to FIG. 2), such as an external computer, via a network.

In the image forming unit 201B, the surfaces of the photosensitive drums 212, which have been uniformly charged to the predetermined polarity and potential by the charge units 213, are sequentially exposed by a laser beam. Thereby, the electrostatic latent images of yellow, magenta, cyan, and black are sequentially formed on the photosensitive drums of each process cartridge 211, respectively.

Thereafter, this electrostatic latent images are developed using the toners of each color and visualized, and the toner images of each color on each photosensitive drum are sequentially overlapped and transferred onto the intermediate transfer belt 216 with primary transfer biases applied to the primary transfer rollers 219. Thereby, the toner image is formed on the intermediate transfer belt 216.

On the other hand, the sheet S fed from the sheet feed unit 230 (or the manual sheet feed portion 235 or the feed deck 800) is conveyed to a registration roller pair 240, which includes a drive roller and a driven roller. At this time, the drive of the registration roller pair 240 is stopped, and a leading edge of the sheet S is abutted against the registration roller pair 240. Thereby, the leading edge of the sheet S is aligned with the registration roller pair 240.

Thereafter, the conveyance of the sheet S is continued by the feed roller 3 (or the feed roller 502 or the feed roller 802) and the like, and a deflection (loop) is formed in the sheet S. Thereafter, the registration roller pair 240 is driven in synchronization with the timing of the toner image on the intermediate transfer belt 216. Thereby, the skew of the sheet S is corrected by the registration roller pair 240, and the sheet S with the skew corrected is conveyed to the secondary transfer portion 201D by the registration roller pair 240.

Subsequently, the toner image is collectively transferred onto the sheet S at the secondary transfer portion 201D with a secondary transfer bias applied to the secondary transfer roller 217. Then, the sheet S onto which the toner image has been transferred is conveyed to the fixing unit 201E, and, by receiving heat and pressure at the fixing unit 201E, the toners of each color are melted and mixed, so that the toner image is fixed on the sheet S as the color image.

Thereafter, the sheet S, on which the image has been fixed, is discharged to the sheet discharge space V by the first or second sheet discharge roller pair 225a or 225b, disposed downstream of the fixing unit 201E in the sheet conveyance direction, and is supported on a supporting portion 223 projecting from a bottom surface of the sheet discharge space V. To be noted, when forming the image on both sides of the sheet S, after fixing the image, the sheet S is conveyed to the reconveyance path R by the reverse roller pair 222, and is once again conveyed to the secondary transfer portion 201D.

### Configuration of Manual Sheet Feed Portion

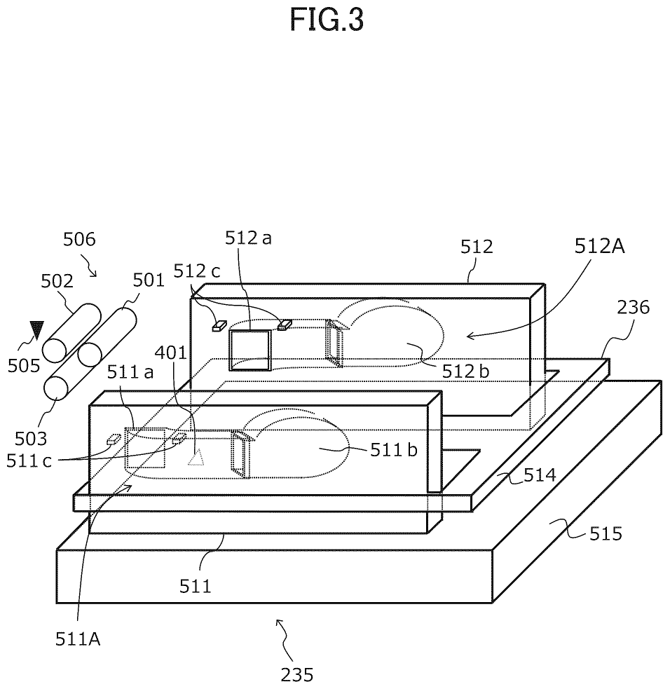

Next, using FIGS. 1 and 3, details of the manual sheet feed portion 235, which is an example of the sheet feeding apparatus, will be described. FIG. 3 is a schematic perspective view illustrating a configuration of the manual sheet feed portion 235 according to this embodiment.

As illustrated in FIGS. 1 and 3, the manual sheet feed portion 235 includes the sheet tray 236, which is an example of a tray and can support the sheet, and the sheet feeding unit 506, which feeds the sheet and separates the sheets that are fed in an overlapping manner. In addition, the sheet feeding unit 506 includes the pickup roller 501 that comes into contact with an uppermost sheet of the sheet bundle and serves as a feed roller to feed the uppermost sheet. Further, the sheet feeding unit 506 includes the feed roller 502 and the retard roller 503, which collectively serve as a separation unit to separate the sheets S fed from the pickup roller 501.

In addition, in the manual sheet feed portion 235, the extraction roller pair 504, which extracts the sheet S from the feed roller 502 and feeds the sheet S to the image forming apparatus 201, is arranged downstream of the feed roller 502 in a sheet feeding direction. Further, between the feed roller 502 and the extraction roller pair 504 in the sheet feeding direction, namely more downstream than the sheet feeding unit 506 in the sheet feeding direction, a feed sensor 505 is arranged. This feed sensor 505 detects the passage of the sheet S by outputting a signal based on the presence and absence of the sheet S. The feed sensor 505 is an example of a detection unit, and detects the feeding of the sheet S by the sheet feeding unit 506.

In addition, as illustrated in FIG. 3, the sheet tray 236 includes a manual feed tray platform 515 and a lifter plate 514 to support the sheet bundle constituted by a plurality of sheets S. In addition, in the lifter plate 514, a sheet presence/absence detection sensor 401, serving as a sheet detection unit to detect that the sheet S is supported on the sheet tray 236. A vertical position of this lift plate 514 is controlled by a lift mechanism, whose illustration is omitted, in accordance with a stacking amount of the sheet S.

In addition, as illustrated in FIG. 3, the sheet tray 236 includes side edge regulation plates 511 and 512, which regulate a position of the sheet S supported by the sheet tray 236 in a width direction perpendicular to the sheet feeding direction. The side edge regulation plates 511 and 512 regulate positions of end portions (side edges of the sheet) in the width direction of the sheet S set on the lifter plate 514. Air blowing units 511A and 512A are respectively disposed in these side edge regulation plates 511 and 512. The air blowing units 511A and 512A blow air to the sheet S supported on the sheet tray 236 to separate the sheets. The air blowing unit 511A includes a fan 511b driven by a fan motor 511M (refer to FIG. 2) and a duct 511a, which guides the air from a side of the sheet bundle by guiding the air emitted from the fan 511b to pass through the interior of the side edge regulation plate 511 such that the air is blown to a side of the sheet. Similarly, the air blowing unit 512A includes a fan 512b driven by a fan motor 512M (refer to FIG. 2) and a duct 512a, which guides the air from a side of the sheet bundle by guiding the air emitted from the fan 512b to pass through the interior of the side edge regulation plate 512 such that the air is blown to a side of the sheet. In addition, on the side edge regulation plates 511 and 512, adjacent to openings of the ducts 511a and 512a, anti-lift plates 511c and 512c are disposed to prevent the sheet S, which is elevated by being blown with the air, from levitating to climb over the side edge regulation plates 511 and 512.

### Configuration of Control System of Image Forming System

Next, using FIG. 2, a configuration of a control system in the image forming system 600 will be described. FIG. 2 is a block diagram illustrating the control system of the image forming system according to this embodiment.

A control unit 100 according to this embodiment is, for example, included in the image forming apparatus 201, and is configured to include a central processing unit (CPU) 101, a read only memory (ROM) 102, and a random access memory (RAM) 103. The control unit 100 is a control means that oversees and controls the image forming apparatus 201, the feed deck 800, and the manual sheet feed portion 235. The control unit 100 is connected to the host apparatus 1500 and the operation unit 730, and, while exchanging information with them, performs signal processing, sequence control, and the like for various processing units. To be noted, the host apparatus 1500 is an external apparatus, such as a personal computer, an image scanner, or a facsimile.

In addition, the control unit 100 is connected to a fan control unit 510, a feed motor 520 serving as a motor that drives the pickup roller 501, a torque measurement unit 520a that measures the motor torque of the feed motor 520, the feed sensor 505, and the like. Further, the control unit 100 is also connected to the sheet presence/absence detection sensor 401, a conveyance motor 521, and the like of the manual feed tray. To be noted, while the torque measurement unit 520a measures the motor torque of the feed motor 520, a current sensor that detects a current value flowing through the feed motor 520, or a torque sensor that detects torque generated at the pickup roller 501 can be used. In other words, the specific configuration of the torque measurement unit 520a can be any configuration as long as it can measure the motor torque of the feed motor 520. The fan control unit 510 controls the rotational operation of the fans 511b and 512b while simultaneously performing fault detection. Whether or not a fault is present can be determined by measuring a rotation speed of the fan and assessing whether or not it reaches an intended rotation speed.

### Operation During Air Blowing

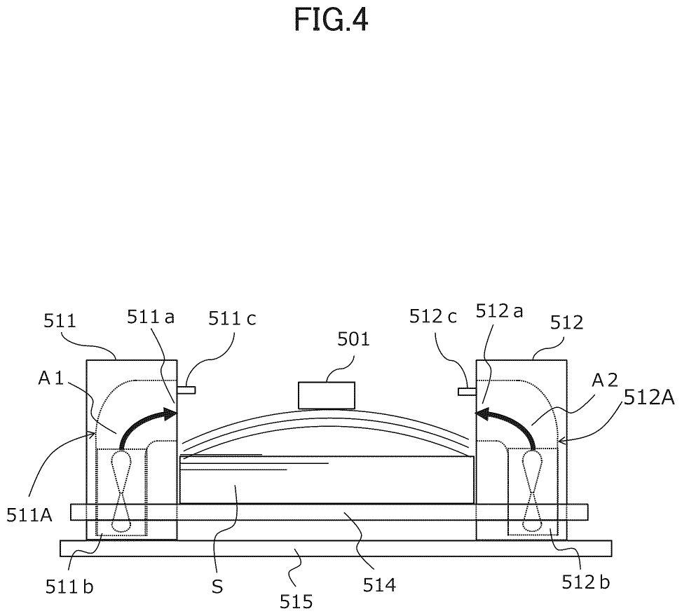

Next, using FIG. 4, an operation performed when the air blowing units 511A and 512A blow the air from the sides of the sheet bundle will be described. FIG. 4 is a schematic side view illustrating a state in which the air blowing operation is performed in the manual sheet feed portion 235 according to this embodiment.

As illustrated in FIG. 4, when the control unit 100 starts the air blowing operation, the fans 511b and 512b of the air blowing units 511A and 512A direct the air toward the side surfaces of the sheet bundle, as indicated by arrows A1 and A2. As a result, several to several dozen sheets located in an upper part of the sheet bundle are separated and lifted, and, as the uppermost sheet S comes into contact with the anti-lift plates 511c and 512c, the elevation of the separated sheet S is suppressed. Thereby, adhesive forces between those sheets S are reduced, and, even in a case of the sheet S that possesses a smooth surface characteristic, such as coated paper, it becomes possible to convey the sheets S using a conveyance force of the pickup roller 501.

Incidentally, in recent years, there is a growing demand for forming images on various types of sheets, and sometimes sheets with a smooth surface, such as coated paper, are used. When a sheet bundle constituted by such sheets with the smooth surface is loaded on the sheet feeding apparatus described above, due to the high adhesive forces between the sheets, there is a risk that the sheets cannot be separated and feeding errors may occur. Here, if new sheets are replenished onto the sheet bundle which has been once subjected to the air blowing operation, there is a risk that replenished unseparated sheets may adhere to each other and may cause the feeding errors. In particular, in a case of the manual feed tray, unlike a feed cassette which is mounted into the image forming apparatus, it is difficult to determine whether or not a sheet has been replenished. On the other hand, even in a case of the feed cassette mounted into the image forming apparatus, even if the air blowing operation is performed prior to the execution of the image forming job, depending on the temperature, humidity, sheet type, or size, there is a possibility that the feeding errors may occur during the execution of the image forming job due to the adhesive forces between the sheets. Therefore, in this embodiment, as described below, when the feeding errors occur, the air blowing operation is performed before reattempting (retrying) a feeding operation.

### Air Blowing Control Upon Occurrence of Feeding Errors

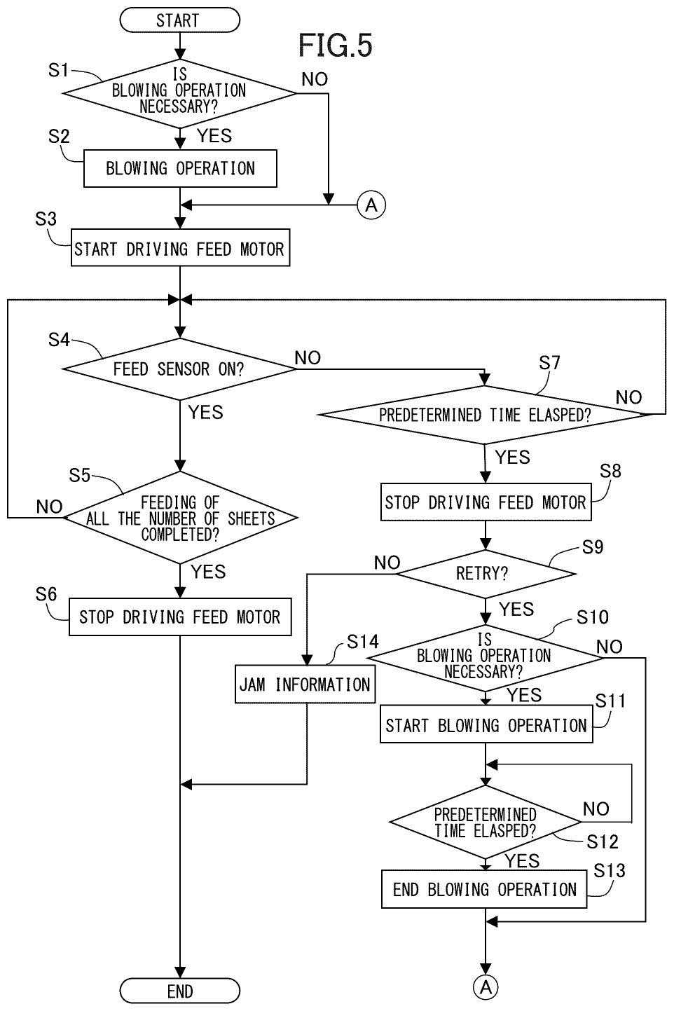

Hereinafter, a retry operation upon the occurrence of the feeding errors in the manual sheet feed portion 235 in this embodiment will be described in accordance with a flowchart illustrated in FIG. 5. Here, the control unit 100 can execute the feeding operation and the blowing operation respectively. The feeding operation is an operation to feed the sheet S by the manual sheet feed portion 235. The blowing operation is an operation to blow the air by the air blowing units 511A and 512A. In addition, the image forming job is an example of a feeding job, which performs the feeding operation for each individual sheet S with respect to one or more sheets.

The control unit 100 acquires a type of the sheet S utilized in that image forming job before starting the image forming job, and determines whether or not it is a type for executing the blowing operation (STEP S1). The type of the sheet S can be acquired based on, for example, information which has been input into the operation unit 730 by the user, or a detection result of the media detection sensor 280. In addition, while, in this embodiment, whether or not the blowing operation is executed is determined before starting the feeding of the sheet S, it is not limited to this, and may be determined as a part of the image forming job. In a case where it is determined that the blowing operation is necessary (STEP S1: YES), the control unit 100 executes the blowing operation for a predetermined time (STEP S2), and then drives the feed motor 520 (STEP S3). That is, in a case of executing the feeding job, before starting an initial feeding operation, the control unit 100 can execute a second blowing mode that executes the blowing operation. On the other hand, in a case where it is determined that the blowing operation is not necessary (STEP S1: NO), the control unit 100 drives the feed motor 520 (STEP S3) without executing the blowing operation.

That is, the control unit 100 acquires the type of the sheet S supported on the sheet tray 236, and, in a case where an acquired type of the sheet S is a first type (for example, coated paper), executes the initial feeding operation after performing the second blowing mode. On the other hand, in a case where the acquired type of the sheet S is different from the first type and is instead a second type (for example, standard paper), the control unit 100 executes the initial feeding operation without performing the second blowing mode.

The control unit 100 determines whether or not the feed sensor 505 is in an ON state, that is, it determines whether or not the feed sensor 505 has detected the sheet S (STEP S4). In a case where it is determined that the feed sensor 505 is in the ON state (STEP S4: YES), the control unit 100 determines whether or not the feeding of all the number of sheets for the image forming job has been completed (STEP S5). In a case where it is determined that the feeding of all the number of sheets for the image forming job has not been completed (STEP S5: NO), the control unit 100 once again determines whether or not the feed sensor 505 is in the ON state (STEP S4). In a case where it is determined that the feeding of all the number of sheets for the image forming job has been completed (STEP S5: YES), the control unit 100 stops the drive of the feed motor 520 (STEP S6) and ends the processing of the image forming job.

On the other hand, in a case where it is determined that the feed sensor 505 is not in the ON state (STEP S4: NO), the control unit 100 determines whether or not a predetermined time has passed since starting the drive of the feed motor 520 (STEP S7). The predetermined time here can be set to, for example, approximately 0.2 to 1.0 seconds. In a case where it is determined that the predetermined time has not passed since starting the drive of the feed motor 520 (STEP S7: NO), the control unit 100 once again determines whether or not the feed sensor 505 is in the ON state (STEP S4). In a case where it is determined that the predetermined time has passed since starting the drive of the feed motor 520 (STEP S7: YES), the control unit 100 determines that the sheet S is not being fed and stops the drive of the feed motor 520 (STEP S8). That is, in a case where the feed sensor 505 does not detect the feeding of the sheet S within the predetermined time after starting the feeding operation, the control unit 100 can perform the retry operation as described below.

In a case where the sheet S is not fed despite executing the feeding operation, the control unit 100 determines whether or not to execute the retry operation to reinitiate the feeding operation (STEP S9). In this embodiment, only one retry operation is permitted for each feeding operation, and, if the sheet S cannot be fed with one retry operation, it is treated as a jam. Therefore, at STEP S9, the control unit 100 determines whether or not it is a retry of the first time regarding that feeding operation. While, in this embodiment, the retry operation is limited to only once per feeding operation, it is not limited to this, and it can be set to two times, or even executions of equal to or more than three times may be allowed.

In a case where it is determined that it is the retry of the first time regarding that feeding operation (STEP S9: YES), the control unit 100 acquires the type of the sheet S, and determines whether or not the sheet S requires the blowing operation (STEP S10). In a case where it is determined that the blowing operation is not necessary (STEP S10: NO), the control unit 100 once again drives the feed motor 520 (STEP S3) as the retry operation. That is, in this case, the control unit 100 executes a third blowing mode that does not perform the blowing operation before executing the retry operation.

In a case where it is determined that the blowing operation is necessary (STEP S10: YES), the control unit 100 starts the blowing operation (STEP S11). To eliminate the feeding errors of the sheet S, the control unit 100 drives the fan motors 511M and 512M of the air blowing units 511A and 512A (refer to FIG. 4), and starts the blowing operation to blow the air to the side surfaces of the sheet bundle (STEP S11). Thereby, several to several dozen sheets located in the upper part of the sheet bundle are separated and lifted with the levitation the sheet S suppressed by the anti-lift plates 511c and 512c (refer to FIG. 4), and the adhesive forces between the sheets S are reduced.

Since the fan motors 511M and 512 M start rotation from a stationary state, a predetermined time, for example, 10 seconds, is set beforehand to account for the time required to reach a desired rotational speed and to ensure the stable levitation of the sheet S. The control unit 100 determines whether or not a predetermined time has passed (STEP S12) while performing the blowing operation. In a case where it is determined that the predetermined time has not passed (STEP S12: NO), the control unit 100 determines whether or not the predetermined time has passed (STEP S12) again. In a case where it is determined that the predetermined time has passed (STEP S12: YES), the control unit 100 ends the blowing operation (STEP S13). Thereby, while the sheet S, which was in the levitated state, attempts to return to a pre-levitated state of the sheet bundle as the air between the sheets escapes, the adhesive forces between the sheets are reduced until the sheets return to the state of the sheet bundle, and the feeding errors are eliminated. Thereafter, the feed motor 520 is driven once again as the retry operation (STEP S3). That is, in this case, after performing the feeding operation and before executing the retry operation, the control unit 100 executes a first blowing mode which performs the blowing operation. Here, in this embodiment, the necessity of the blowing operation is determined at STEP S10 based on the type of the sheet, and the determination result is the same as STEP S1. Therefore, the first blowing mode is executed in a case where the second blowing mode has been executed. In addition, the determination of the necessity of the blowing operation is not limited to that performed based on the sheet type at STEP S10, and the necessity of the blowing operation may be determined based on the execution of the second blowing mode.

As described above, in a case where the sheet S is not fed in the image forming job despite the feeding operation has been executed, the control unit 100 interrupts the image forming job, and executes the first blowing mode and the retry operation. Then, in a case where the retry operation has been executed and the sheet S is fed, the control unit 100 restarts the image forming job.

On the other hand, in a case where it is determined that it is not the first retry for that feeding operation (STEP S9: NO), by assuming that the sheet S is not being fed despite the retry operation, the control unit 100 determines that the jam has occurred, and stops the execution of the image forming job. In a case of stopping the execution of the image forming job, on the operation unit 730, the control unit 100 displays the information that the execution of the image forming job has been stopped. While, in this embodiment, the operation unit 730 is applied as the output portion that outputs information, it is not limited to this, and, for example, the output portion may be configured as an external interface to output the jam information to external devices such as the host apparatus 1500.

As described above, according to the manual sheet feed portion 235 of this embodiment, after the execution of the feeding operation and before the execution of the retry operation, it is possible to execute the first blowing mode that performs the blowing operation. Therefore, it is possible to suppress the occurrence of the feeding errors of the sheet S. That is, in a case where a new sheet S has been replenished on top of the sheet bundle, onto which the air was previously once blown, and the feeding errors occur during the subsequent printing operation, by executing the blowing operation before performing the retry, it is possible to eliminate the feeding errors by reducing the adhesive forces at the upper part of the sheet bundle. In addition, in a case where the sheet was replenished and the feeding errors has occurred, since the user is not required to remove and manually separate the sheets S on the sheet tray 236, usability can be improved.

According to this disclosure, it is possible to prevent the occurrence of the feeding errors of the sheet.

### Other Embodiments

To be noted, while, in the embodiment described above, the sheet feeding apparatus is applied as the manual sheet feed portion 235 of the image forming apparatus 201, it is not limited to this. For example, the sheet feeding apparatus may be applied to the sheet feed units 230 housed within the image forming apparatus 201 and the feed deck 800.

In addition, while, in the embodiment described above, in a case of the occurrence of the feeding errors, the first blowing mode is executed only in a case where the second blowing mode was executed before the initial feeding operation of the image forming job, it is not limited to this. For example, the first blowing mode may be executed also in a case where the second blowing mode was not executed before the initial feeding operation of the image forming job. In this case, even in a case where the blowing operation is not executed due to user misunderstanding, regardless of a type of the sheet for which the blowing operation is inherently required, the blowing operation can be performed when the feeding errors have occurred.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113320, filed Jul. 16, 2024 which is hereby incorporated by reference herein in its entirety.

What is claimed is:

1. A sheet feeding apparatus comprising:
a tray disposed at a side part of an apparatus body and configured to support a sheet;
a feed unit configured to feed the sheet supported on the tray;
a detection unit configured to detect that the sheet has been fed by the feed unit;
an air blowing unit configured to blow air to the sheet supported on the tray; and
a control unit configured to execute a feeding operation to feed the sheet by the feed unit and a blowing operation to blow the air by the air blowing unit, respectively,
wherein the control unit is configured to:
execute a retry operation to re-execute the feeding operation in a case where the detection unit does not detect feeding of the sheet within a predetermined time after executing the feeding operation; and
execute a first blowing mode to execute the blowing operation after executing the feeding operation and before executing the retry operation.

2. The sheet feeding apparatus according to claim 1, wherein, in a case where the sheet is not fed despite executing the feeding operation in a feeding job in which the feeding operation is executed for each sheet with respect to one or more sheets, the control unit is configured to pause the feeding job and execute the first blowing mode and the retry operation.

3. The sheet feeding apparatus according to claim 2, wherein the control unit is configured to restart the feeding job in a case where the retry operation was executed and the sheet has been fed.

4. The sheet feeding apparatus according to claim 2,
wherein the control unit is configured to execute a second blowing mode which executes the blowing operation before executing an initial feeding operation in a case of executing the feeding job, and
wherein the control unit is configured to execute the first blowing mode in a case where the control unit executed the second blowing mode.

5. The sheet feeding apparatus according to claim 4,
wherein the control unit is configured to acquire a type of the sheet supported on the tray,
wherein the control unit is configured to execute the initial feeding operation after executing the second blowing mode in a case where the type of the sheet is a first type, and
wherein the control unit is configured to execute the initial feeding operation without executing the second blowing mode in a case where the type of the sheet is a second type that is different from the first type.

6. The sheet feeding apparatus according to claim 2, wherein the control unit is configured to stop execution of the feeding job in a case where the sheet is not fed despite executing the retry operation.

7. The sheet feeding apparatus according to claim 6,
further comprising an output portion configured to output information,
wherein in a case of having paused the execution of the feeding job, the control unit is configured to output information to the output portion that the execution of the feeding operation has been stopped.

8. The sheet feeding apparatus according to claim 1, wherein the control unit is configured to execute a third blowing mode which does not execute the blowing operation before executing the retry operation.

9. The sheet feeding apparatus according to claim 1,
further comprising a side edge regulation plate configured to move in a width direction perpendicular to a sheet conveyance direction and configured to regulate a position in the width direction of the sheet supported on the tray,
wherein the air blowing unit includes:
a fan; and
a duct which is configured to guide the air blown from the fan to pass through an interior of the side edge regulation plate such that the air is blown to a side of the sheet.

10. An image forming apparatus comprising:
the sheet feeding apparatus according to claim 1; and
an image forming unit configured to form an image on the sheet.
